(19) United States
(12) Patent Application Publication
(10) Pub. No.: US 2005/0216924 A1
(43) Pub. Date: Sep. 29, 2005

(54) Optical disc recording/reproducing device

(75) Inventor: Ming-Hsing Lu, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/086,385

(22) Filed: Mar. 23, 2005

(30) Foreign Application Priority Data
Mar. 23, 2004 (TW) 93107843

(51) Int. Cl. G11B 17/03; G11B 17/04; G11B 33/02

(52) U.S. Cl. 720/601; 720/646

(57) ABSTRACT

An optical disc recording/reproducing device including an optical disc recording/reproducing body, a tray, and a panel is provided. The optical disc recording/reproducing body has a first indention having a floating region and a positioning region. The tray removably disposed on the optical disc recording/reproducing body has a second indention. The door, having a first protrusion and a second protrusion respectively corresponding to a first indention and a second indention, is disposed on the tray via a flexible connection, so that the door is fed into the second indention via the second protrusion. When the tray enters the optical disc recording/reproducing body, the first indention of the optical disc recording/reproducing body abuts the first protrusion of the door via the floating region, so that the second protrusion is detached from the second indention along with the door and that the first protrusion slides to the positioning region from the floating region.

This application claims the benefit of Taiwan application Serial No. 93107843, filed Mar. 23, 2004, the subject matter of which is incorporated herein by reference.

### BACKGROUND OF THE INVENTION

1. Field of the Invention

The invention relates in general to a recording/reproducing device, and more particularly to an optical disc recording/reproducing device.

2. Description of the Related Art

As an optical disc recording/reproducing device, digital versatile disc player (DVD player) is one of the most prospective multi-media audio/video players.

DVD player is used to replace audio/video products such as video compact disc player (VCD player), Laser disc player (LD player) and video recorder currently available in the market. The newest model of DVD player is even incorporated with optical disc burning function and becomes a DVD-R/RW player.

Referring to FIG. 1, a schematic diagram of a conventional VCD player is shown. Conventional VCD player 100 includes an optical disc recording/reproducing body 102, a tray 104 and a door 106. The optical disc recording/reproducing body 102 has a panel 108.

The tray 104, which is removably disposed on the optical disc recording/reproducing body 102, is for carrying the optical disc to enter/exit the optical disc recording/reproducing body 102, so that the optical disc can be placed in the optical disc recording/reproducing body 102.

Refer to both FIG. 1 and FIG. 2. FIG. 2 is a top view of a tray equipped with a door. Normally, a rectangular via-hole for carrying the tray 104 of the optical disc enter/exit optical disc recording/reproducing body 102 is disposed on the panel 108.

When the tray 104 enters the optical disc recording/reproducing body 102, the door 106 moves along with the tray 104. When tray 104 halts at a recording/reproducing position of optical disc, the door 106 is embedded into the rectangular via-hole; moreover, the surface of the door 106 is aligned with the surface of the panel 108.

Generally speaking, in the conventional VCD player 100, the door 106 and the tray 104 are coupled and firmly jointed together. So, the clearance between the door 106 and the panel 108 can only be adjusted by moving the position of the tray 104 forward/backward when disposed on the optical disc recording/reproducing body 102 for the surface of the door 106 to be aligned with that of the panel 108 when the tray 104 enters the optical disc recording/reproducing body 102.

Due to the accumulated tolerance during the manufacturing of the VCD player 100, the door 106 is not aligned with the panel 108 leading to uneven clearance between the door 106 and the panel 108 when the door 106 is embedded into the rectangular via-hole.

The problem of uneven clearance between the door 106 and the panel 108 not only affects the appearance and configuration of the VCD player 100, but also disables the door 106 to block the noise generated by the elements inside the optical disc recording/reproducing body 102 during operation.

### SUMMARY OF THE INVENTION

It is therefore an object of the invention to provide an optical disc recording/reproducing device having an even clearance between the door and the panel of the optical disc recording/reproducing device, so as to improve the configuration of the optical disc recording/reproducing device and block the noise generated by the elements inside the optical disc recording/reproducing body during operation.

The invention achieves the above-identified object by providing an optical disc recording/reproducing device. The optical disc recording/reproducing device includes an optical disc recording/reproducing body, a tray and a door. The optical disc recording/reproducing body has a first indention, which has a floating region and a positioning region. The tray, which is removably disposed on the optical disc recording/reproducing body, has a second indention. The door, which has a first protrusion and a second protrusion respectively corresponding to a first indention and a second indention, is disposed on the tray via a flexible connection, so that the door is fed into the second indention of the tray via the second protrusion. When the tray enters the optical disc recording/reproducing body, the first indention of the optical disc recording/reproducing body abuts the first protrusion of the door via floating region, so that the second protrusion is detached from the second indention of the tray along with the door and that the first protrusion slides to the positioning region from the floating region.

The abovementioned optical disc recording/reproducing device according to the invention can further include an elastomer, while the abovementioned flexible connection can be achieved by connecting the tray with the door via the elastomer. Besides, the optical disc recording/reproducing device can further include a screw fixed to the tray, while elastomer has a first terminal side and a second terminal side. The elastomer is firmly jointed with the door via a first terminal side and is firmly jointed with the screw via a second terminal side.

Moreover, in the abovementioned optical disc recording/reproducing device according to the invention, the optical disc recording/reproducing body can include a panel, and the first indention is disposed on the panel. The first indention can have an inclined plane and a bottom. The floating region is positioned on the inclined plane, while the positioning region is positioned on the bottom. Besides, the abovementioned second protrusion can be an awl-shaped protrusion, while the optical disc recording/reproducing device can be a DVD player.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a conventional VCD player;

FIG. 2 is a top view of a tray equipped with a door;

FIG. 3A is a schematic diagram of an optical disc recording/reproducing body of the optical disc recording/reproducing device according to the invention;

FIG. 3B is a front view of FIG. 3A;

FIG. 4 is a schematic diagram of the first indention;

FIG. 5A is an assembly diagram of the tray and door of the optical disc recording/reproducing device according to the invention;

FIG. 5B is a perspective view of FIG. 5A;

FIG. 6 is a partial enlargement of a schematic diagram of FIG. 5B;

FIG. 7 is a schematic diagram showing the tray enters the optical disc recording/reproducing body enabling the first protrusion to be fed into the first indention; and

FIG. 8 is a schematic diagram showing the relative position between the door and the panel.

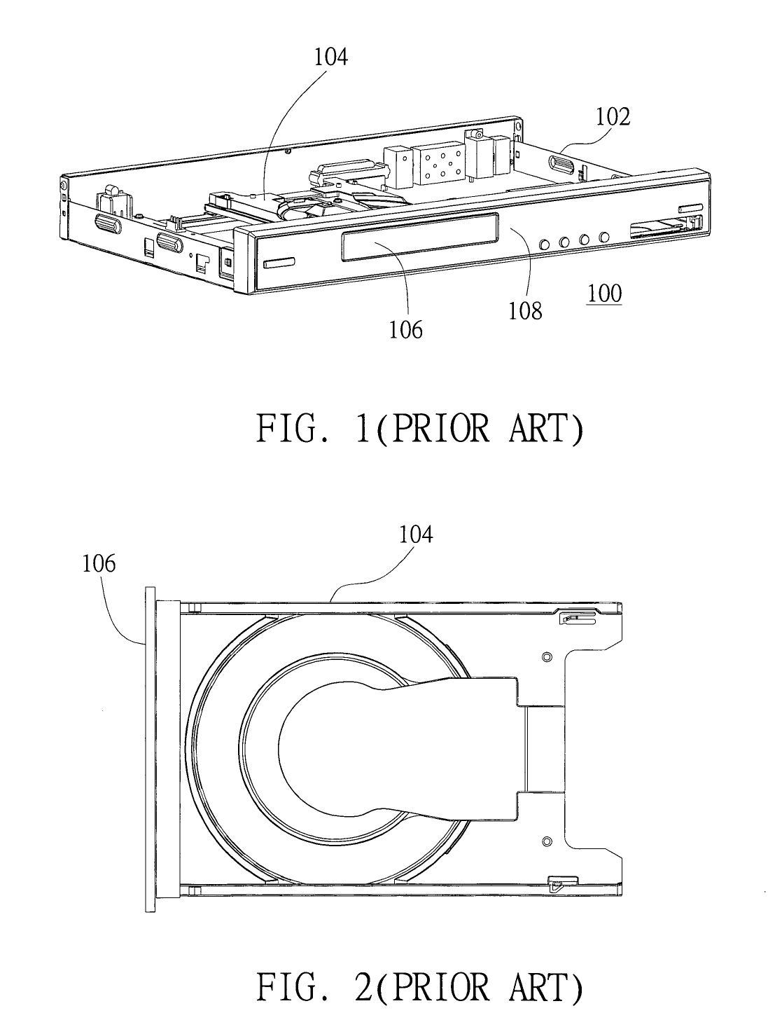

### DETAILED DESCRIPTION OF THE INVENTION

The invention is exemplified by means of a preferred embodiment. However, the preferred embodiment of the invention is not intended to limit the scope of protection. The preferred embodiment of the invention is an optical disc recording/reproducing device under the spirit of the invention. The technical characteristics of the invention are disclosed below.

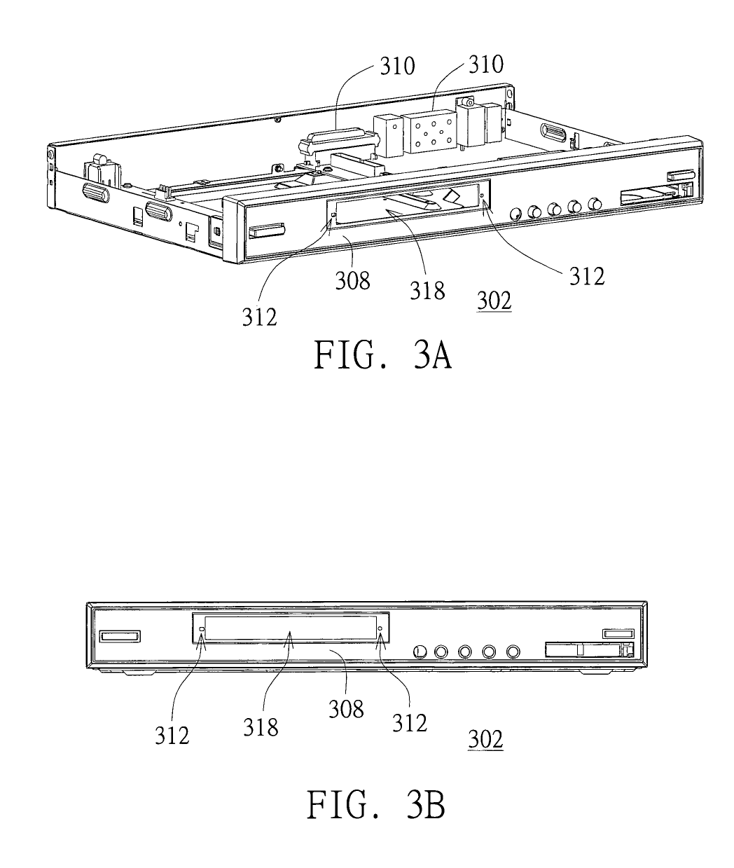

Refer to both FIG. 3A, a schematic diagram of an optical disc recording/reproducing body of the optical disc recording/reproducing device according to the invention, and FIG. 3B, a front view of FIG. 3A. Optical disc recording/reproducing body 302 includes a panel 308 and a plurality of electronic elements 310.

The panel 308 is disposed at the front end of the optical disc recording/reproducing body 302. The electronic elements 310 such as the drive motor which drives the tray to move, the spindle motor which drives the optical disc to rotate, and the pick-up head which accesses the optical disc are disposed inside the optical disc recording/reproducing body 302.

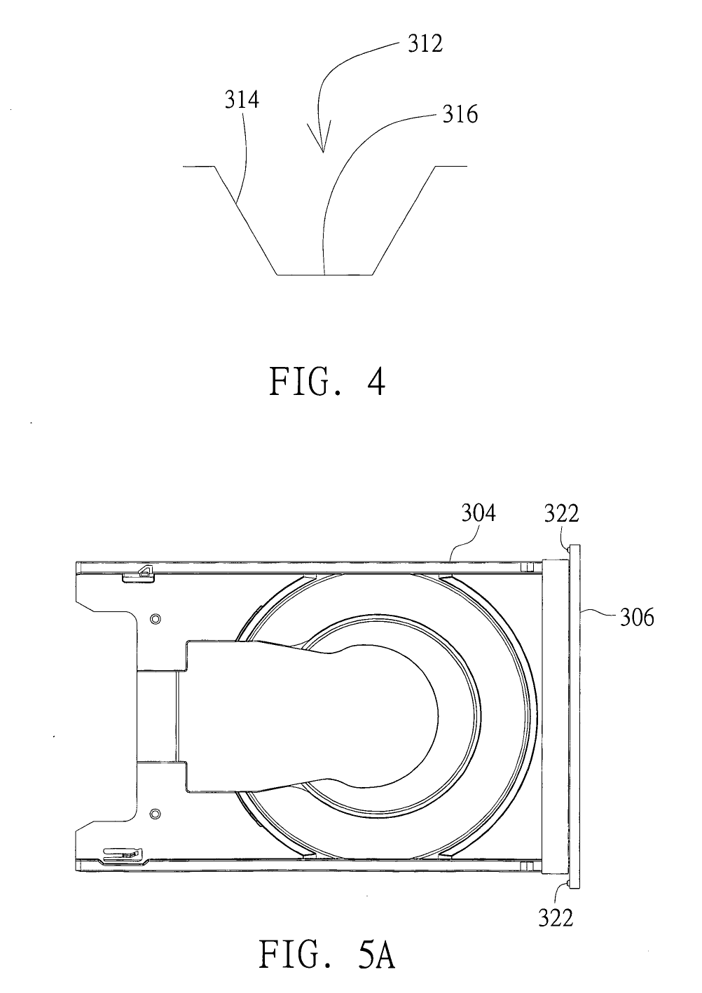

The panel 308 has a first indention 312. The first indention 312 has an inclined plane 314 and a bottom 316 as shown in FIG. 4. Moreover, the first indention 312 has a floating region and a positioning region. The floating region is positioned on the inclined plane 314, while the positioning region is positioned on the bottom 316.

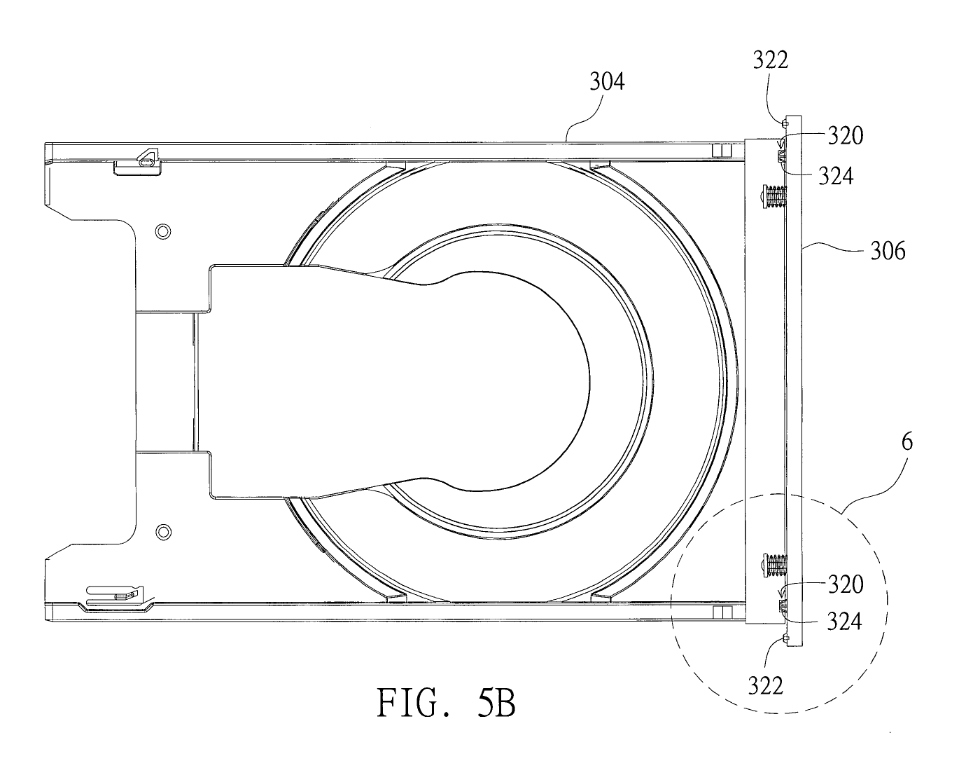

Refer to both FIG. 5A, an assembly diagram of the tray and door of the optical disc recording/reproducing device according to the invention, and FIG. 5B, a perspective view of FIG. 5A. The optical disc recording/reproducing device such as a digital versatile disc player (DVD player) according to the invention includes an optical disc recording/reproducing body 302 as shown in FIG. 3A and a tray 304 and a door 306 as shown in FIG. 5A.

The tray 304 is removably disposed on the optical disc recording/reproducing body 302 for carrying to optical disc to enter/exit optical disc recording/reproducing body 302 via a rectangular via-hole 318 in FIG. 3A, so that the optical disc can be deposited in the optical disc recording/reproducing body 302.

Moreover, the tray 304 has a second indention 320. The door 306 has a first protrusion 322 and a second protrusion 324 respectively corresponding to a first indention 312 and a second indention 320 in FIG. 3A.

The door 306 is disposed on the tray 304 via a flexible connection, so that the door 306 can be fed into the second indention 320 of the tray 304 via a second protrusion 324.

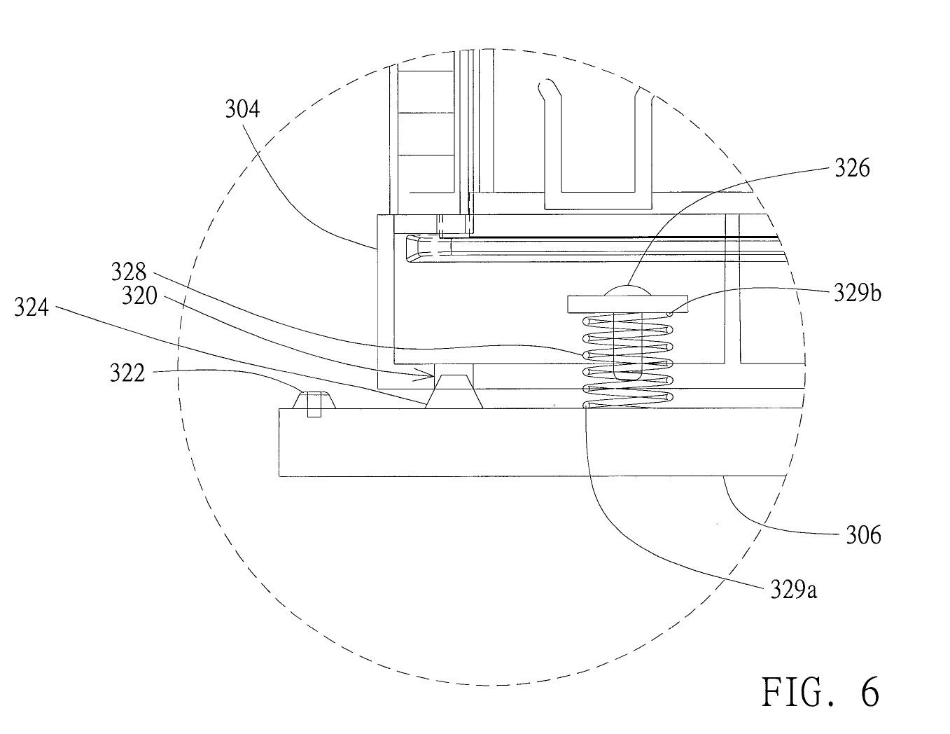

Referring to FIG. 6, a partial enlargement of a schematic diagram of FIG. 5B is shown. The optical disc recording/reproducing device according to the invention further includes a screw 326 and an elastomer such as a spring 328. The screw 326 is fixed to the tray 304. It can be seen from the diagram that the above flexible connection can be achieved by using a first terminal side 329a of the spring 328 to be firmly jointed with the door 306 and using a second terminal side 329b of the spring 328 to be firmly jointed with screw 326. That is to say, the above flexible connection can be achieved by connecting the tray 304 and the door 306 via the spring 328.

FIG. 6 shows how the door 306 and tray 304 are connected via the above flexible connection. Meanwhile, the spring 328 applies a pulling force onto the door 306, so that the second protrusion 324, which is an awl-shaped protrusion, can be fed into second indention 320.

Since the second protrusion 324 is an awl-shaped protrusion, when the second protrusion 324 receives the applying force from the spring 328, the slanting surface of the second protrusion 324 will slide in correspondence to the edge of the second groove 320 for the second protrusion 324 to completely contact the edge of the second groove 320.

The position where the awl-shaped second protrusion 324 completely comes into contact with the edge of the second groove 320 is the best position for the door 306 to be disposed on the tray 304.

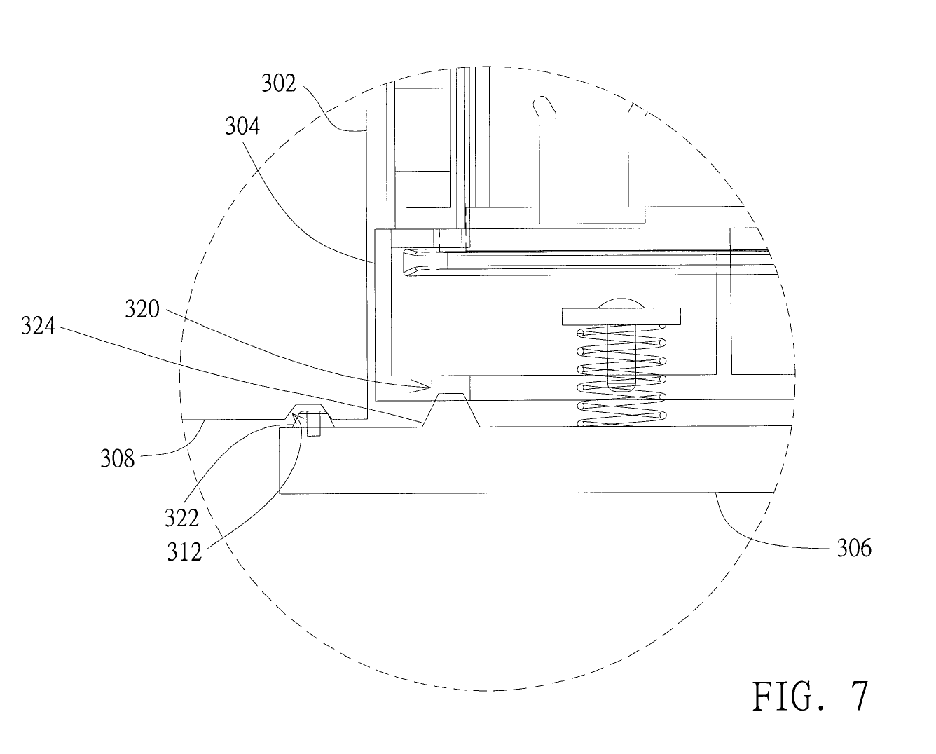

Referring to FIG. 7, a schematic diagram showing the tray enters the optical disc recording/reproducing body enabling the first protrusion to be fed into the first indention is shown. As shown in the diagram, when the tray 304 enters the optical disc recording/reproducing body 302, the first indention 312 of the optical disc recording/reproducing body, abuts the first protrusion 322 of the door 306 via the floating region positioned on the inclined plane 314 in FIG. 4, so that the second protrusion 324 can be detached from the second indention 320 of tray 304 along with the door 306.

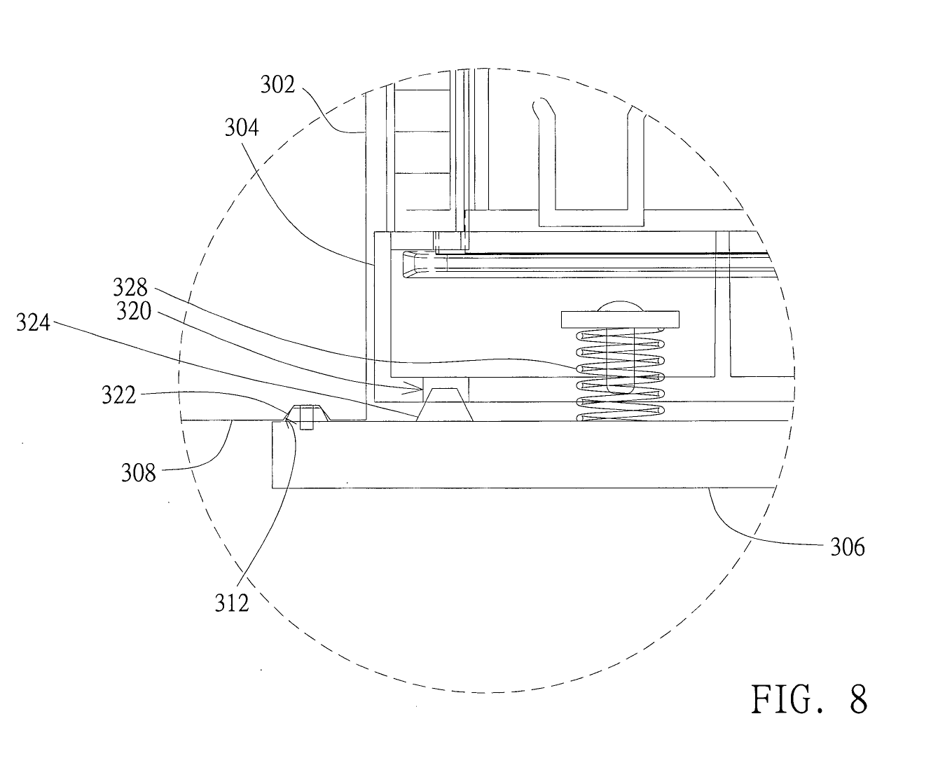

Referring to FIG. 8, a schematic diagram showing the relative position between the door and the panel is shown. When the second protrusion 324 is detached from the second indention 320 of the tray 304 along with the door 306, meanwhile, the door 306 is still at a free state. That is, the door 306 is adjustable.

As shown in FIG. 7, when the first protrusion 322 abuts the inclined plane 314 of the first groove 312, the first protrusion 322 is at a floating and unstable state. That is, the first protrusion 322 tends to slides towards a stable state.

Therefore, the unrestricted door 306 can be carried by the first protrusion 322 to move towards a stable position. The pulling force that the spring 328 applies on the door 306 will force the first protrusion 322 to move towards the positioning region positioned on the bottom 316 of the first indention 312.

After the first protrusion 322 has moved to the positioning region, the door 306 is at a best position corresponding to the panel 308. Meanwhile, the tray 304 completely enters the optical disc recording/reproducing body; the tray 304 is at a recording/reproducing position corresponding to the optical disc recording/reproducing body. Moreover, the clearance between the door 306 and the panel 308 is completely even as designed.

According to the above disclosure, the optical disc recording/reproducing device according to the invention has the following advantages. Since the door and the tray inside the optical disc recording/reproducing device are coupled via a flexible connection, an even clearance between the door and the panel can be achieved. Moreover, not only can the optical disc recording/reproducing device have an improved configuration, but also the door can block the noise generated when the elements of the optical disc recording/reproducing body are operating.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An optical disc recording/reproducing device comprising:
an optical disc recording/reproducing body having a first indention, wherein the first indention has a floating region and a positioning region;
a tray which is removably disposed on the optical disc recording/reproducing body and has a second indention; and
a door, which has a first protrusion and a second protrusion respectively corresponding to the first indention and the second indention, wherein the door is disposed on the tray via a flexible connection so that the door is fed into the second indention of the tray via the second protrusion;
wherein when the tray enters the optical disc recording/reproducing body, the first indention of the optical disc recording/reproducing body abuts the first protrusion of the door via the floating region, so that the second protrusion is detached from the second indention of the tray along with the door and the first protrusion slides to the positioning region from the floating region.

2. The optical disc recording/reproducing device according to claim 1 further comprising an elastomer, wherein the flexible connection is achieved by using the elastomer to connect the tray with the door.

3. The optical disc recording/reproducing device according to 2 further comprising a screw fixed to the tray, wherein the elastomer has a first terminal side and a second terminal side, and the elastomer is firmly jointed with the door via first terminal side and with the screw via the second terminal side.

4. The optical disc recording/reproducing device according to claim 1, wherein the optical disc recording/reproducing body comprises a panel, and the first indention is disposed on the panel.

5. The optical disc recording/reproducing device according to claim 1, wherein the first indention has an inclined plane on which the floating region is positioned and a bottom on which the positioning region is positioned.

6. The optical disc recording/reproducing device according to claim 1, wherein the second protrusion is an awl-shaped protrusion.

7. The optical disc recording/reproducing device according to claim 1, wherein the optical disc recording/reproducing device is a digital versatile disc player (DVD player).

8. A player, comprising:
an optical disc recording/reproducing body;
a panel disposed on the optical disc recording/reproducing body, wherein the panel has a first indention, and the first indention has an inclined plane and a bottom;
a tray which is removably disposed on the optical disc recording/reproducing body and has a second indention; and
a door, which has a first protrusion and a second protrusion respectively corresponding to the first indention and the second indention, wherein the door is disposed on the tray via a flexible connection so that the door is fed into the second indention of the tray via the second protrusion;
wherein when the tray enters the optical disc recording/reproducing body, the first indention of the optical disc recording/reproducing body abuts the first protrusion of the door via an inclined plane so that the second protrusion is detached from the second indention of the tray along with the door and that the first protrusion slides to the bottom from the inclined plane of the first indention.

9. The player according to claim 8 further comprising an elastomer, wherein the flexible connection is achieved by using the elastomer to connect the tray with the door.

10. The player according to claim 9 further comprising a screw fixed to the tray, wherein the elastomer has a first terminal side and a second terminal side, and the elastomer is firmly jointed with the door via the first terminal side and with the screw via the second terminal side.

11. The player according to claim 8, wherein the second protrusion is an awl-shaped protrusion.
